(19) United States
(12) Patent Application Publication
(10) Pub. No.: US 2025/0021214 A1
(43) Pub. Date: Jan. 16, 2025

(54) MANAGING DRIFT IN ENDPOINT DEVICES

(71) Applicant: Dell Products L.P., Round Rock, TX (US)

(72) Inventors: MAHESH BABU RAMAIAH, Bangalore (IN); JOSEPH CAISSE, Burlington, MA (US); SUDHANSU SEKHAR SAHU, Bangalore (IN)

(21) Appl. No.: 18/350,171

(22) Filed: Jul. 11, 2023

(51) Int. Cl. G06F 3/0484; G06F 11/30; G06F 11/32

(52) U.S. Cl. CPC G06F 3/0484; G06F 11/3041; G06F 11/321

(57) ABSTRACT

Methods and systems for manage operation of endpoint devices are disclosed. To manage the operation of endpoint devices, drift in the endpoint devices may be monitored. The monitoring be used to granularly characterize different types of drift impacting the endpoint device, and quantify the level of each type of drift experienced by the endpoint devices. The types and quantifications may be used to select actions to perform to manage the drift. By managing the drift, the impact of the drift on operation of the endpoint devices may be reduced.

### FIELD

Embodiments disclosed herein relate generally to device management. More particularly, embodiments disclosed herein relate to managing device drift.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B and 2D-2E show data flow diagrams in accordance with an embodiment.

FIG. 2C shows a diagram of a graphical user interface in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for management of the operation of endpoint devices. To manage the operation of endpoint devices, monitoring for drift in the operation of the endpoint device may be performed. When drift is detected, the drift may be granularly characterized.

For example, different types of drift may be identified. The different types of drift may also be quantified.

Once characterized, actions to manage the drift may be selected based on the different types and quantifications of the drift. Once selected, the actions may be performed. Performing the actions may modify the manner in which an endpoint device operates thereby reducing, compensating for, and/or otherwise managing the drift.

To select the different types of actions, a graphical user interface may be used to present information regarding the types and quantifications of the drift. For example, a radar chart or other type of graphical representation may be included in the graphical user interface. The chart may reduce the cognitive burden on a user for identifying how the draft is impacting operation of the endpoint device. Using the graphical user interface, the user may also provide user input to facilitate selection of actions to perform to address draft in endpoint devices.

By doing so, embodiments disclosed herein may facilitate management of endpoint devices in distributed systems where the endpoint devices may be subject to drift. Thus, embodiments disclosed herein may address, among others, the technical problem of device drift over time. By managing device drift, endpoint devices in accordance with embodiments disclosed herein may be more likely to provide desired computer implemented services.

In an embodiment, a method for managing operation of an endpoint device is provided. The method may include identifying environmental conditions impacting the endpoint device and component conditions of components the endpoint device; updating a digital twin for the endpoint device using the environmental conditions and the component conditions to obtain an updated digital twin; identifying a drift of the endpoint device based on the updated digital twin; and updating operation of the endpoint device based on the drift to manage the endpoint device.

The digital twin may be a model of the endpoint device, and the model may include a set of dimensions based on characteristics of the endpoint device. Each dimension of the set of dimensions may have a corresponding scale that is based on the environmental conditions.

The model may include a set of values corresponding to the set of dimensions, and each value of the set of values may range within the corresponding scale for a corresponding dimension of the set of dimensions. Each value of the set of values may be based on the component conditions (and/or dependency values from other characteristics).

At least one value of the set of values may also be based on a second value of the set of values.

Identifying the drift of the endpoint device may include displaying, to a user, a graphical user interface based on the updated digital twin; obtaining, from the user, user input indicating a modification to operation of a component of the components; and adding the modification to an action set performed during the updating of the operation of the endpoint device.

The graphical user interface may include a graph include a number of axes corresponding to at least a portion of the characteristics of the endpoint device; and a plot that crosses the number of axes based on a corresponding value of the characteristics of the endpoint device.

Updating the operation of the endpoint device may include at least one update operation selected from a group of update operations consisting of: modifying a software component hosted by the endpoint device; modifying a configuration of a software component or a hardware component of the endpoint device; and disabling a hardware component of the endpoint device.

Updating the operation of the endpoint device may also include: selecting the at least one update operation based on a type of the drift, the selected at least one update operation selected to reduce an impact of the drift on the operation of the endpoint device.

Updating the digital twin for the endpoint device using the environmental conditions and the component conditions to obtain an updated digital twin may include obtaining a first new value for a first characteristic of the endpoint device specified by the digital twin based on a first component condition of the component conditions; and obtaining a second new value for a second characteristic of the endpoint device specified by the digital twin based on a second component condition of the component conditions and the first new value.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

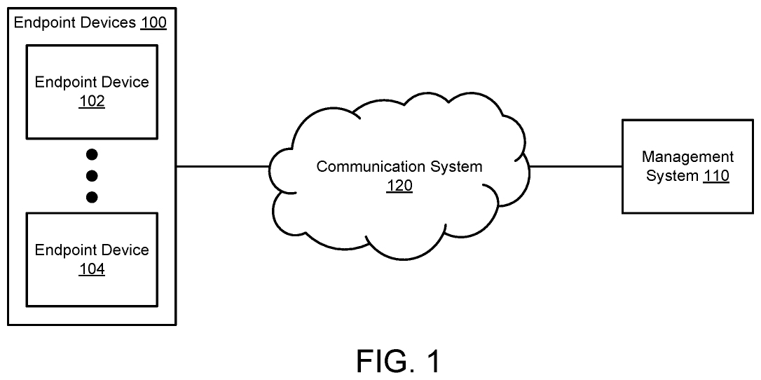

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system may include endpoint devices 100. Each endpoint device (e.g., 102, 104) may provide similar and/or different computer implemented services, and may provide the computer implemented services independently and/or in cooperation with other endpoint devices.

To provide the services, each of endpoint devices 100 may host computer code that when executed causes the endpoint devices to provide corresponding computer services. Additionally, the hardware and/or software configurations of endpoint devices 100 may impact the manner in which the computer implemented services are provided. Changes in the hardware, software, and/or conditions impacting endpoint devices 100 may result in drift in endpoint devices 100 that causes the operation of endpoint devices 100 to diverge from that expected under nominal conditions.

For example, modifying the computer code hosted by endpoint devices 100 may cause endpoint devices 100 to provide different types of computer implemented services. The computer code may correspond to applications, virtual machines, containers, etc.

In another example, degradation of a hardware component may cause any of endpoint devices 100 to provide computer implemented services in a different manner. The degradation of the hardware component may cause errors in activity by endpoint devices 100 to provide the services, may change the rate at which the services are provided, etc.

In a further example, the environment conditions to which any of endpoint devices 100 are exposed may impact the ability of endpoint devices 100 to provide the computer implemented services. Changes in ambient temperature may limit the rate at which heat may be removed from hardware components which may in turn reduce a maximum rate at which the computer implemented services may be provided.

In general, embodiments disclosed herein may provide methods, systems, and/or devices for managing the computer services provided by endpoint devices 100. To manage the computer implemented services provided by endpoint devices, drift in endpoint devices 100 may be monitored over time. The monitored drift may be used to select when and how to modify endpoint devices 100 to manage impacts of drift on the endpoint devices.

For example, based on the type of drift identified over time, remedial actions may be selected and performed. The remedial actions may be selected based on the type of drift and/or impact of the drift. When performed, the remedial actions may better align operation of endpoint devices 100 with desired operation (e.g., nominal operation).

To monitor for drift of endpoint devices 100, telemetry data for various components of endpoint devices 100 may be obtained. The telemetry data may include, for example, logs regarding the operation of endpoint devices 100, reports of environmental conditions near endpoint devices 100, status updates from endpoint devices 100, etc. The telemetry data may be collected in accordance with any type of telemetry data collection model.

The obtained telemetry data may be used to update models of endpoint devices 100. The models may be digital twins for endpoint devices 100 that track characteristics of endpoint devices 100. The characteristics may include (i) software and/or hardware component characteristics (e.g., states of storage devices, memory devices, etc.; states of software components), (ii) functionality characteristics (e.g., security states, software states, firmware states, etc.), and/or other types of characteristics of endpoint devices 100.

The characteristics defined by the digital twins may be updated with a model that takes into account (i) environmental conditions impacting endpoint devices 100, (ii) states of software components and hardware components of endpoint devices 100, and (iii) drift in the characteristics of endpoint devices 100. For example, when a change in state of a hardware component occurs, a corresponding characteristic of a digital twin model may be updated. However, in addition to this characteristic, other characteristics of the digital twin model that depend on this first characteristic may be updated. This, in turn, may lead to changes in other characteristics of the digital twin model that have a degree of dependency on these other characteristics.

The characteristics specified by the digital twin models may have quantifiable values that range within a scale defined by nominal operation of corresponding endpoint devices. Real world operation of endpoint devices 100 may cause the quantifiable values to fall below the maximum of the scale, and these differences may reflect drift in endpoint devices 100.

Based on a drift in operation of an endpoint device, various actions may be selected and performed to manage impacts of the drift on continued operation of the endpoint device. The actions may be selected via automated and/or semiautomated processes.

In automated processes, the type of drift may be used to select potential remedial actions to perform. The remedial actions may be selected using a library of remedial actions keyed to the types of drifts, and/or via other methods.

Once selected, semiautomated processes may be performed to present the potential remedial actions along with information regarding the drift to a user. For example, a graphical user interface may be displayed that graphically illustrates the identified drift and/or the potential remedial actions to address the drift. The user may authorize and/or deny performing any of the potential remedial actions.

Once authorized, the potential remedial actions may be performed to update operation of an endpoint device. The remedial actions may include, for example, modifying software components, hardware/software component configurations, disabling hardware components, and/or other types of actions that may improve the likelihood of the endpoint device providing desired computer implemented services.

By doing so, different types of drift in endpoint devices may be identified and used as basis for selection and performance of remedial action. By tailoring the remedial actions to the types of drift impacting the endpoint devices, the endpoint devices may be more likely to be updated in a manner that results in more desirable computer implemented services being provided (e.g., by reducing the drift, compensating for the drift, etc.).

To provide the above noted functionality, the system of FIG. 1 may include endpoint devices 100 and management system 110. Each of these components is discussed below.

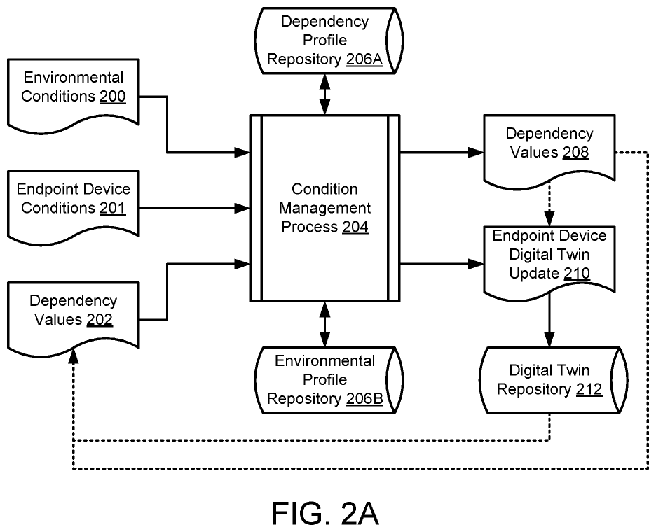

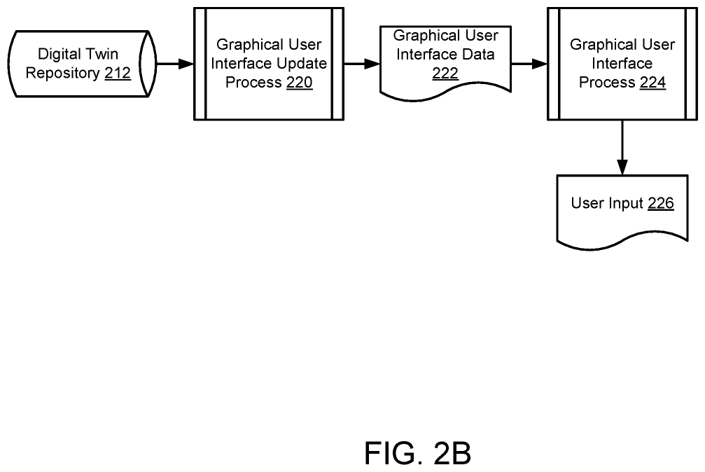

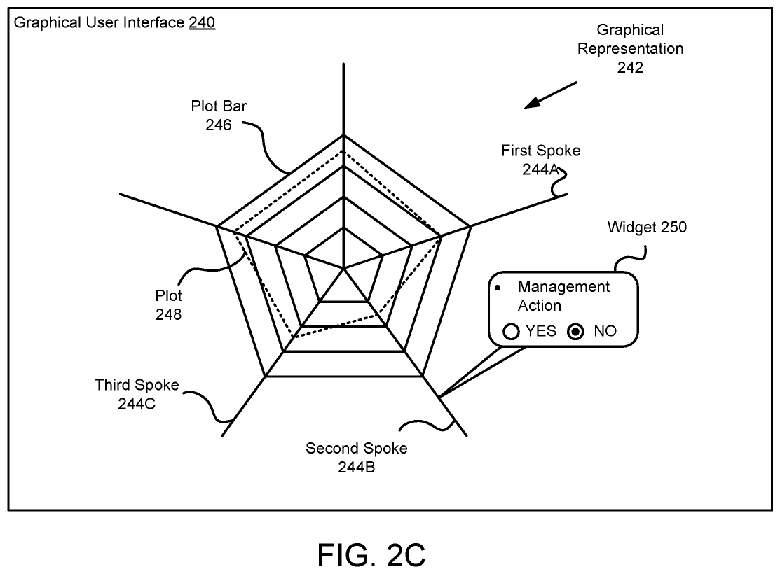

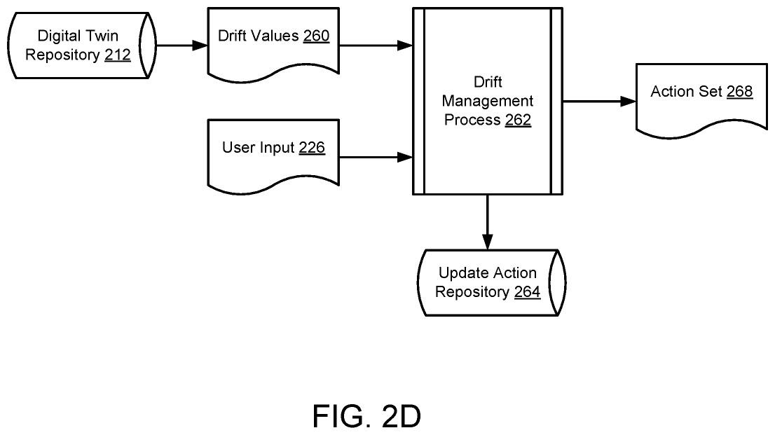

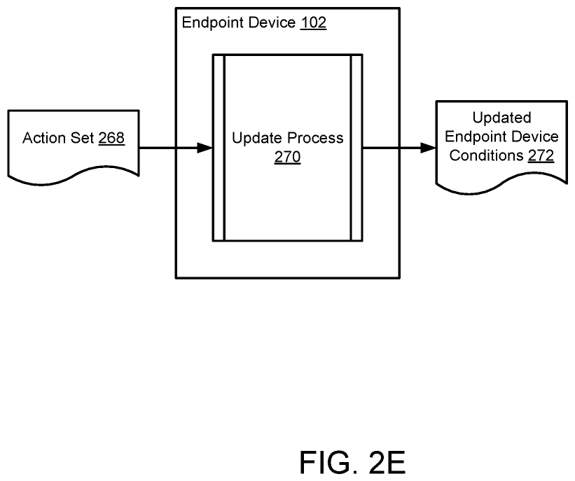

Endpoint devices 100 may provide computer implemented services. To provide the computer implemented services, endpoint devices 100 may cooperate with management system 110 to identify and manage drift. When to do so, an endpoint device may (i) provide information (e.g., logs reflecting activity of the endpoint device, state updates reflecting states of components of the endpoint device, etc.) regarding its operation to management system 110 and/or information regarding environmental conditions to which the endpoint device is exposed, and (ii) perform actions requested by management system 110 to update its operation. By updating its as requested by management system 110, the endpoint device may be more likely to provide desired computer implemented services through reduced drift and/or compensation in operation to account for the drift. Refer to FIGS. 2A-2E for additional details regarding updating the operation of endpoint devices 100.

Management system 110 may manage the computer implemented services provided by endpoint devices 100. To manage the computer implemented services provided by an endpoint device, management system 110 may (i) obtain information regarding conditions impacting and operation of the endpoint device, (ii) update a model of the endpoint device based on the obtained information, (iii) use the updated model to identify drift in the endpoint device, and (iv) initiate performance of various actions to manage the drift in the endpoint device. To select some of the various actions, a graphical user interface may be presented to a user. The graphical user interface may include a graphical representation of a score card for the endpoint device regarding drift in various characteristics of the endpoint device. The graphical user interface may be used, for example, to educate the user regarding condition of the endpoint device and solicit user input regarding actions to perform to manage drift exhibited by the endpoint device. Refer to FIGS. 2A-2E for additional details regarding management of endpoint devices 100 by management system 110.

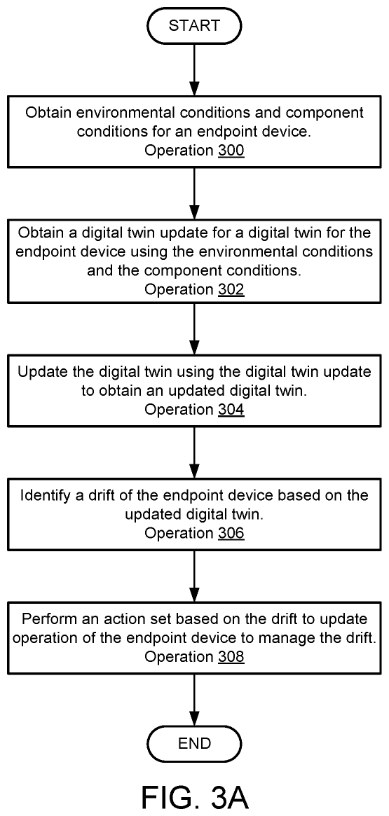

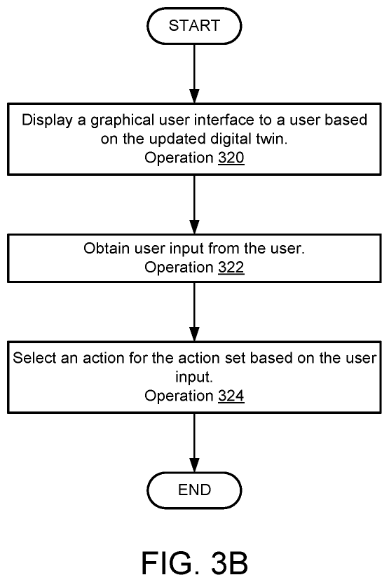

When providing their functionality, any of (and/or components thereof) endpoint devices 100 and/or management system 110 may perform all, or a portion, of the methods illustrated in FIGS. 3A-3B.

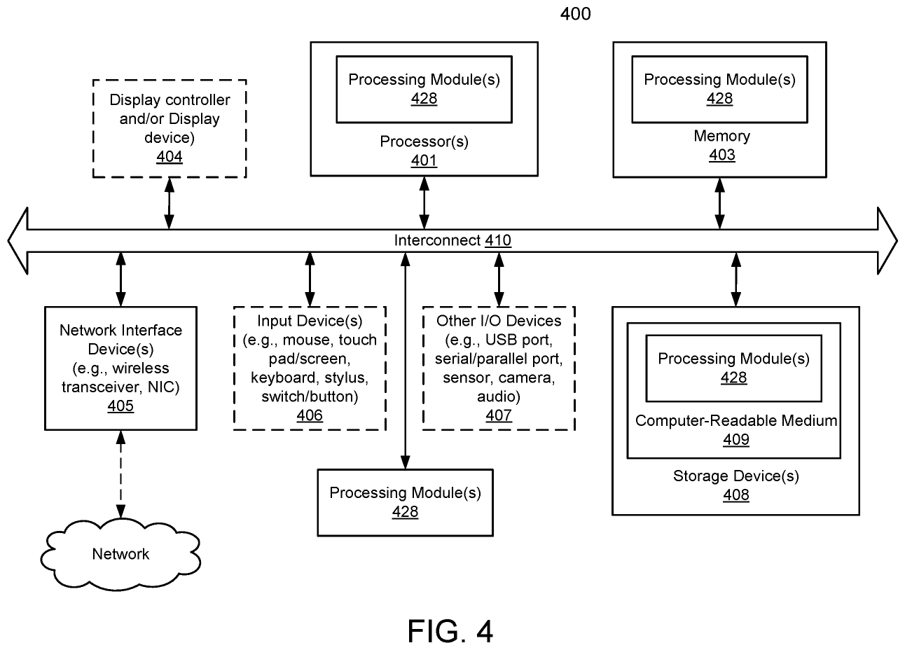

Any of (and/or components thereof) endpoint devices 100 and management system 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B and 2D-2E. In these diagrams, flows of data and processing of data are illustrated using different sets of shapes. A first set of shapes (e.g., 200, 201, 202, etc.) is used to represent data structures, a second set of shapes (e.g., 204, etc.) is used to represent processes performed using and/or that generate data, and a third set of shapes (e.g., 206A, 206B, etc.) is used to represent large scale data structures such as databases. Additionally, an example graphical user interface is shown in FIG. 2C. The graphical user interface may utilize any of the data structures and processes discussed with respect to FIGS. 2A-2B and 2D-2E.

Turning to FIG. 2A, a first data flow diagram in accordance with an embodiment is shown. The first data flow diagram may illustrate data used in and data processing performed in maintaining digital twin models that represent endpoint devices.

To manage a digital twin for an endpoint device (e.g., 102), condition management process 204 may be performed. During condition management process 204, a digital twin for the endpoint device may be updated.

To update the digital twin, information regarding conditions impacting the endpoint device may be obtained. For example, environmental conditions 200 and endpoint device conditions 201 may be obtained.

Environmental conditions 200 may include information regarding how the endpoint device is being impacted due to its physical location. For example, the information may include temperatures to which the endpoint device is exposed, humidity levels in the air, and/or other factors from the environment that is likely to impact operation of the endpoint device.

As will be discussed in greater detail below, environmental conditions 200 may be used to establish expected ranges over which quantifications of characteristics of the operation of the endpoint device are expected to run. The characteristics of operation of the endpoint device may include, for example, (i) performance levels of various systems of the endpoint device, (ii) performance levels of functions of various systems of the endpoint device, and/or other performance ratings for the operation of the endpoint device.

Endpoint device conditions 201 may include any type and quantity of telemetry data. The telemetry data may include any type and quantity of information regarding operation of the endpoint device. For example, the telemetry data may include logs regarding operation of the endpoint device over time. The logs may include information regarding operation of software and/or hardware components of the endpoint device such as occurrences of events, performance of processes, changes in configuration, etc.

As will be discussed in greater detail below, endpoint device conditions 201 may be used to establish, in part, quantifications of characteristics of the operation of the endpoint device (which are expected to fall within the ranges establish using the environmental conditions, and are maximized when no drift has occurred). Dependency values 202 may also be used to establish the quantifications.

To establish the quantifications for the characteristics of operation of the endpoint device, a sub-model for each characteristic may be used. The sub-model for each characteristic may take into account some of the data from endpoint device conditions 201 as well as quantifications for other characteristics of operation of the endpoint device.

For example, a digital twin for an endpoint device may include a first characteristic for performance of a storage system of the endpoint device and a second characteristic for performance of a memory system of the endpoint device. The sub-model for the characteristic for performance of the storage system may depend on conditions impacting storage devices of the endpoint device (e.g., as specified by endpoint device conditions 201). However, the sub-model for the second characteristic for performance of the memory system may take into account both (i) conditions impacting memory devices of the endpoint device and (ii) the quantification of the performance of the storage system.

For example, the sub-model for the second characteristic may reduce a quantification for performance of the memory system based in part on how far the quantification for performance of the storage system falls below the maximum possible performance level (e.g., as specified by a corresponding range for the first characteristic). Thus, the quantification for any characteristic tracked by the digital twin may depend both on the information regarding the operation of components of the endpoint device, but also on other characteristics. Accordingly, to compute a quantification for any characteristic, both of a portion of endpoint device conditions 201 and a portion of dependency values 202 may be used.

Dependency values 202 may be values obtained from the computation of quantifications of any characteristic of an endpoint device. Dependency values 202 may be obtained from the calculation of quantifications of the characteristics (e.g., shown as dependency values 208), or from digital twin repository 212 (in which the quantifications may be stored after the calculations are performed in memory).

During condition management process 204, as noted above, (i) the ranges for each characteristic may be obtained, and (ii) quantifications for each characteristic may be obtained.

To obtain the ranges, profiles from environmental profile repository 206B may be used. Environmental profile repository 206B may include profiles for ranges of characteristics of the operation of an endpoint device. Each profile may specify a range for a characteristic that depends on environmental conditions 200. The profile may specify the corresponding range based on a formula, a lookup table, and/or other data structure that ingests all or a portion of environmental conditions 200 and outputs the range.

The profiles may be developed, for example, in a laboratory setting prior to deployment of an endpoint device. In the laboratory setting, the endpoint device may be exposed to a range of different conditions and the responses to these conditions may be established. For example, changing the ambient temperature may modify the rate at which a processing system is able to process data (e.g., reduced maximum processing rate with increased temperature). By exposing the endpoint device to a variety of temperatures, a profile for the performance of the processing system may be developed that defines that maximum range for performance of the processing system in terms of the temperature. While described with respect to a single variable (i.e., temperature), it will be appreciated that a profile may take into account any number of variables reflecting the environment in which the endpoint device may be positioned.

To obtain the quantifications for each characteristic, a sub-model corresponding to the characteristic may be used. The sub-model may include a formula, a lookup table, and/or other data structure that ingests all or a portion of endpoint device conditions 201 and dependency values 202, and outputs the quantification for the characteristic. The sub-models may be adapted to provide quantifications fall within the corresponding range for the characteristic.

The quantifications for each characteristic may be obtained in an order such that all necessary dependency values 208 are obtained prior to their use. For example, the sub-models that do not depend on any dependency values may be used to obtain some of the characteristics first. Once obtained, some (or all) of dependency values 208 may be obtained.

As noted above, any of dependency values 208 may depend on the difference between the maximum range for a characteristic, and the quantification for the characteristic. For example, if a range for a characteristic runs from 0 to 1, and a quantification for the characteristic is 0.8, then the dependency value may be the difference of 0.2 (e.g., 1-0.8) between the maximum attainable quantification for the characteristic and the quantification. It will be appreciated though that dependency values 208 may be related to the difference by a factor, via a formula, and/or other type of relationship. Thus, the difference may not be the value used in sub-models (or the sub-model may include the relationship, thereby allowing for direct use of the difference). However, the difference between the quantification and maximum range for the quantification may be treated as a quantification of drift of the endpoint device with respect to that characteristic of the endpoint device. Consequently, these differences in aggregate may be a multidimensional quantification of the drift of the endpoint device from a nominal or expected operation. As will be discussed with respect to FIGS. 2B-2E, these quantifications of the drift of the endpoint device may be used to select how to modify operation of the endpoint device and/or otherwise manage the endpoint device.

These relationships may be stored in dependency profile repository 206A. For example, dependency profile repository 206A may store the sub-models for characteristics of operation of the endpoint device as corresponding profiles. The sub-models may specify the relationship between the delta between the maximum attainable quantification for a characteristic and the quantification for the characteristic and the corresponding dependency value. For example, the relationship may be formula such as dependency value=delta/2 (or another scaling factor).

While the sub-models have been described for simplicity with respect to dependence on a single dependency value, it will be appreciated that the sub-models may specify that quantifications for characteristics in terms of any number of endpoint device conditions and any number of dependency values for any number of other characteristics. For example, a sub-model may specify that a quantification for performance of a memory system as the actual performance of the memory device (e.g., as specified by endpoint device conditions 201), reduced by a first dependency value for a storage system and a second dependency value for a processing system.

Once the ranges, quantifications, and dependency values are obtained, the ranges quantifications, and dependency values may be used to obtain endpoint device digital twin update 210. Endpoint device digital twin update 210 may be used to update a digital twin for the endpoint device. The digital twin may be stored in digital twin repository 212.

For example, endpoint device digital twin update 210 may replace values in the digital twin such that the digital twin includes the updated values.

Once obtained, a digital twin for an endpoint device may be used to update operation of the endpoint device based on drift indicated by the digital twin.

Turning to FIG. 2B, a second data flow diagram in accordance with an embodiment is shown. The second data flow diagram may illustrate data used in and data processing performed in managing an endpoint device.

To manage an endpoint device, a digital twin for the endpoint device from digital twin repository 212 may be ingested by graphical user interface update process 220 to update a graphical user interface used to present information regarding operation of the endpoint device and solicit user input on how to manage the endpoint device. During graphical user interface update process 220, graphical user interface data 222 may be generated. Graphical user interface data 222 may include data regarding how to display a plot based on the digital twin. The plot may convey to the user the ranges and quantifications regarding operation of the digital twin. Refer to FIG. 2C for additional details regarding the graphical user interface.

For example, graphical user interface data 222 may specify instructions on how to construct the plot within a display area of the graphical user interface. The instructions may specify how to light pixels to display the plot. The plot may be a radar chart or other type of chart that allows a user to explore the characteristics of the operation of the endpoint device as specified by the digital twin.

Graphical user interface data 222 may be ingested by graphical user interface process 224. During graphical user interface process 224, the graphical user interface may be updated to display the chart, to solicit user input 226, and/or to otherwise interact with the user. Refer to FIG. 2C for additional details regarding the graphical user interface, charts to convey information regarding operation of an endpoint device to a user, and solicitation of user input.

Turning to FIG. 2C, a diagram of graphical user interface 240 in accordance with an embodiment is shown. Graphical user interface 240 may be displayed to a user to provide the user with information regarding operation of an endpoint device (e.g., in particular drift in operation of the endpoint device) and solicit user input.

To provide the user with information, graphical user interface 240 may include graphical representation 242. Graphical representation 242 may be radar chart or other type of chart usable to convey information to a user.

The radar chart may include (i) any number of spokes (e.g., 244A, 244B, axes of the chart) corresponding to characteristics of the operation of the endpoint device, (ii) plot bars (e.g., 246 that define the ranges over which a quantification for each characteristic runs, and (iii) plot 248 (drawn in dashing for clarity) that indicates the quantification for each characteristic.

For example, first spoke 244A may be associated with the characteristic of the performance of the processing system of the endpoint device and second spoke 244B may be associated with the characteristic of the performance of the memory system of the endpoint device. As seen in FIG. 2C, the example plot 248 extends to the second to last plot bar 246 along first spoke 244A but retracts to midway between the fourth to last and third to last plot bar 246 along second spoke 244B. Thus, plot 248 here may indicate that the performance of the processing system has drifted from nominal (e.g., the last plot bar) based on the environmental conditions, but the performance of the memory system has drifted significantly more from nominal when compared to the drift of the processing system performance.

When presented to a user, the user may rapidly identify this more significant drift of the performance of the memory system and prioritize management of that aspect of the performance of the endpoint device. For example, while not shown, text or other indicators may be positioned with each spoke so that the user may quickly identify graphical which characteristics are exhibiting higher levels of drift. Consequently, the user may more efficiently prioritize addressing more pressing issues based on the multidimensional drift of an endpoint device.

However, it will be appreciated that the user may prioritize certain type of performance rather than just magnitude of drift. For example, consider a scenario in which the endpoint device is tasked with processing sensitive data. In such scenarios, performance of security of the endpoint device may be of higher importance than any other characteristic of the operation of the endpoint device. In that scenario, the user may quickly scan third spoke 244C (e.g., presuming that it is associated with the security characteristic) to identify the level of security performance provided by the endpoint device.

Returning to the discussion of the example scenario where the user may identify that the performance of the memory system significantly drifted, the user may interact with second spoke 244B or other portions of graphical user interface 240 to invoke widget 250. Widget 250 may be an interactive element that provides information to the user and solicits user input. Widget 250 may do so by displaying information (e.g., “management action”) regarding actions that may be performed to attempt to reduce the drift of the performance of the memory system and/or compensate for the drift. Additionally, widget 250 may include radio buttons or other interactive elements that a user may use a pointing device or other human interface device to interact. For example, widget 250 may include radio buttons soliciting user input regarding whether various management actions may be performed. If a user authorizes performance of the management actions, the management actions may be automatically performed. Refer to FIGS. 2D-2E for additional details regarding selection and implementation of management actions.

Turning to FIG. 2D, a third data flow diagram in accordance with an embodiment is shown. The third data flow diagram may illustrate data used in and data processing performed in selecting actions to perform to manage drift in endpoint devices.

To manage drift in endpoint device, drift values 260 for an endpoint device may be obtained from a digital twin stored in digital twin repository 212. As discussed above, each drift value may be a difference between a quantification for a characteristic and a maximum of the range over which the characteristic runs. Thus, any number of drift values corresponding to any number of characteristics tracked by a digital twin may be obtained from the digital twin.

Once obtained, drift values 260 may be ingested by drift management process 262. During drift management process 262, actions for action set 268 may be selected. The actions added to action set 268 may be selected to manage an impact of the drift in operation of the endpoint device.

To select the actions, information from update action repository 264 may be used. Update action repository 264 may store actions associated with different types (e.g., different characteristics) of drift. The actions and associations to corresponding types of drift may be established, for example, by a subject matter expert, via automated processes (e.g., automated analysis of previously performed actions and outcomes regarding drift management), and/or via other methods. Using the information in update action repository 264, one or more actions may be selected for each of drift values 260.

To select the one or more actions, the type and/or magnitude of the drift may be used as a key to identify (e.g., via a lookup or other action) the one or more actions from update action repository 264. For example, update actions repository 264 may include actions associated with different types of drift and/or different magnitudes of drift.

In addition, user input 226 may also be taken into account. For example, actions identified using update action repository 264 may be used to populate widgets of the graphical user interface described with respect to FIG. 2C. The user input may be used to decide whether to add one or more of the selected actions to the action set.

Once selected, the one or more actions may be added to action set 268 based on user input 226. Consequently, any number and types of actions corresponding to the types of drift for an endpoint device may be added to action set 268. Action set 268 may be used to update operation of an endpoint device.

Turning to FIG. 2E, a fourth data flow diagram in accordance with an embodiment is shown. The fourth data flow diagram may illustrate data used in and data processing performed in updating operation of endpoint device 102. While described with respect to endpoint device 102, it will be appreciated that the illustrated and described processes may be performed with respect to any endpoint device.

To update the operation of endpoint device 102, action set 268 may be provided to endpoint device 102 and ingested by updated process 270. During update process 270, endpoint device 102 may perform any of the actions specified by action set 268. The actions may include, as noted above, modifying operation, configuration, and/or other aspects of hardware components and/or software components of endpoint device 102.

Once and/or as the actions are performed, updated endpoint device conditions 272 may be obtained. Like endpoint device conditions (e.g., 201, FIG. 2A), updated endpoint device conditions 272 may include any type and quantity of information regarding the operating condition of the now updated endpoint device 102.

Updated endpoint device conditions 272 may be used in condition management process 204 to update the digital twin corresponding to endpoint device 102. Consequently, quantifications regarding the drift of the now-updated endpoint device 102 may be obtained. Accordingly, additional iterative cycles of drift management process 262 may be performed as the drift of endpoint device 102 is managed.

Thus, using the data structures and flows shown in FIGS. 2A-2E, embodiments disclosed herein may facilitate drift identification, quantification, and management.

As discussed above, the components of FIG. 1 may perform various methods to manage the operation of endpoint devices. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with and/or in a partially overlapping in time manner with other operations.

Turning to FIG. 3A, a first flow diagram illustrating a method for managing operation of an endpoint device in accordance with an embodiment is shown. The method may be performed by any of endpoint devices 100, management system 110, and/or other components of the system shown in FIG. 1.

Prior to operation 300, an endpoint device may be deployed to a deployment or other computing environment. A management system may be assigned to manage the endpoint device.

At operation 300, environmental conditions and components conditions for an endpoint device are obtained. The environmental conditions and component conditions (e.g., of the endpoint device) may be obtained by reading them from storage, by receiving them from another device, and/or by generating them.

For example, the environmental conditions may be monitored by the endpoint device or another device. The device may provide the environmental conditions to the management system.

Similarly, the components conditions may be monitored by the endpoint device (e.g., through logging, alerting, etc.). The endpoint device may provide the component conditions to the management system.

At operation 302, a digital twin update for a digital twin for the endpoint device is obtained using the environmental conditions and the component conditions. The digital twin update may be obtained by obtaining ranges (for characteristics of operation of the endpoint device that are tracked by the digital twin) based on the environmental conditions. The digital twin update may also be obtained by obtaining quantifications for the characteristics using the component conditions and/or dependency values based on some of the characteristics. The resulting digital twin update may specify new values for values of the digital twin (e.g., the values may define the ranges, the quantifications, etc. for operation of the endpoint device).

At operation 304, the digital twin is updated using the digital twin update to obtain an updated digital twin. The digital twin may be updated by modifying values of the digital based on the digital twin update.

At operation 306, a drift of the endpoint device is identified based on the updated digital twin. The drift may be identified using automated and/or semiautomated processes. The automated processes may include calculating drift values based on the digital twin, and comparing the drift values to criteria (e.g., thresholds) that define when drifts have occurred for different characteristics. The semiautomated processes may include displaying, to a user, a graphical user interface based on the updated digital twin; obtaining, from the user, user input indicating a modification to operation of a component of the components; and adding the modification to an action set performed during the updating of the operation of the endpoint device. The semiautomated processes may be performed similar to as described with respect to generation and use of the graphical user interface shown in FIG. 2C.

The graphical user interface may include a graph that includes a number of axes corresponding to at least a portion of the characteristics of the endpoint device; and a plot (e.g., of the quantifications of the characteristics) that crosses the number of axes. The point at which the plot crosses each axis, compared to the maximum range for the axes, may indicate a level of drift of the characteristic. Refer to FIG. 3B for additional details regarding identifying drift.

At operation 308, an action set is performed based on the drift to update operation of the endpoint device to manage the drift. The operation of the endpoint device may be updated by performing one or more of: modifying a software component hosted by the endpoint device; modifying a configuration of a software component or a hardware component of the endpoint device; and disabling a hardware component of the endpoint device. Any of the selected actions to be performed to update operation of the endpoint device may be based on a type of a drift of a characteristic. The selected actions may reduce an impact of the drift on operation of the endpoint device (e.g., through drift reduction, through compensation, etc.).

The method may end following operation 308.

Using the method shown in FIG. 3A, embodiments disclosed herein may reduce undesired impacts of drift on operation of endpoint devices through analysis of different types of drift impacting the endpoint device and granular selection of actions to address these different types of drift. To select any of the actions, a user may utilize a graphical user interface.

Turning to FIG. 3B, a second flow diagram illustrating a method for identifying drift in endpoint devices in accordance with an embodiment is shown. The method may be performed by any of endpoint devices 100, management system 110, and/or other components of the system shown in FIG. 1.

At operation 320, a graphical user interface is displayed to a user. The graphical user interface may include a chart, plot, or other graphical representation interpretable by a user. The graphical representation may be a radar chart that allows the user to identify granular drift with respect to different characteristics in the operation of the endpoint device. For example, some of the characteristics may reflect operation of different software/hardware components, while other characteristics may reflect different functionalities provided by the endpoint device (which may depend on the operation of the software/hardware components).

At operation 322, user input from the user is obtained. The user input may be obtained by the user interacting with the graphical user interface. For example, the user may select portions of the graphical representation. Such selection may cause information regarding a corresponding characteristic to be displayed (e.g., via a widget). The information may include potential remediation actions that may be performed to manage impact of the drift of the characteristic. The user may authorize or deny performance of any of the remediation actions (e.g., by selecting corresponding radio buttons or other interactive features) to provide the user input.

At operation 324, an action for the action set is selected based on the user input. The action may be selected based on the user input (e.g., authorized actions may be selected).

The method may end following operation 324.

Thus, using the method shown in FIG. 3B, a cognitive load on a user may be reduced by providing for granular drift to be determined, and corresponding remediation actions to be granularly authorized and/or denied for performance.

Any of the components illustrated in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of an endpoint device, the method comprising:
identifying environmental conditions impacting the endpoint device and component conditions of components the endpoint device;
updating a digital twin for the endpoint device using the environmental conditions and the component conditions to obtain an updated digital twin;
identifying a drift of the endpoint device based on the updated digital twin; and
updating operation of the endpoint device based on the drift to manage the endpoint device.

2. The method of claim 1, wherein the digital twin is a model of the endpoint device, and the model comprising a set of dimensions based on characteristics of the endpoint device.

3. The method of claim 2, wherein each dimension of the set of dimensions has a corresponding scale that is based on the environmental conditions.

4. The method of claim 3, wherein the model comprises a set of values corresponding to the set of dimensions, and each value of the set of values ranges within the corresponding scale for a corresponding dimension of the set of dimensions.

5. The method of claim 4, wherein each value of the set of values is based on the component conditions.

6. The method of claim 5, wherein at least one value of the set of values is also based on a second value of the set of values.

7. The method of claim 2, wherein identifying the drift of the endpoint device comprises:
displaying, to a user, a graphical user interface based on the updated digital twin;
obtaining, from the user, user input indicating a modification to operation of a component of the components; and
adding the modification to an action set performed during the updating of the operation of the endpoint device.

8. The method of claim 7, wherein the graphical user interface comprises a graph comprising:
a number of axes corresponding to at least a portion of the characteristics of the endpoint device; and
a plot that crosses the number of axes based on a corresponding value of the characteristics of the endpoint device.

9. The method of claim 1, wherein updating the operation of the endpoint device comprises at least one update operation selected from a group of update operations consisting of:
modifying a software component hosted by the endpoint device;
modifying a configuration of a software component or a hardware component of the endpoint device; and
disabling a hardware component of the endpoint device.

10. The method of claim 9, wherein updating the operation of the endpoint device further comprises:
selecting the at least one update operation based on a type of the drift, the selected at least one update operation selected to reduce an impact of the drift on the operation of the endpoint device.

11. The method of claim 1, wherein updating the digital twin for the endpoint device using the environmental conditions and the component conditions to obtain an updated digital twin comprises:
obtaining a first new value for a first characteristic of the endpoint device specified by the digital twin based on a first component condition of the component conditions; and
obtaining a second new value for a second characteristic of the endpoint device specified by the digital twin based on a second component condition of the component conditions and the first new value.

12. A non-transitory machine-readable medium having instructions stored therein, which when executed by at least one processor, cause a system to perform system first operations for managing operation of an endpoint device, the system first operations comprising:
identifying environmental conditions impacting the endpoint device and component conditions of components the endpoint device;
updating a digital twin for the endpoint device using the environmental conditions and the component conditions to obtain an updated digital twin;
identifying a drift of the endpoint device based on the updated digital twin; and
updating operation of the endpoint device based on the drift to manage the endpoint device.

13. The non-transitory machine-readable medium of claim 12, wherein the digital twin is a model of the endpoint device, and the model comprising a set of dimensions based on characteristics of the endpoint device.

14. The non-transitory machine-readable medium of claim 13, wherein each dimension of the set of dimensions has a corresponding scale that is based on the environmental conditions.

15. The non-transitory machine-readable medium of claim 14, wherein the model comprises a set of values corresponding to the set of dimensions, and each value of the set of values ranges within the corresponding scale for a corresponding dimension of the set of dimensions.

16. The non-transitory machine-readable medium of claim 15, wherein each value of the set of values is based on the component conditions.

17. A management system, comprising:
a processor; and
a memory coupled to the processor to store instructions, which when executed by the processor, cause the management system to perform operations for managing operation of an endpoint device, the operations comprising:
identifying environmental conditions impacting the endpoint device and component conditions of components the endpoint device;
updating a digital twin for the endpoint device using the environmental conditions and the component conditions to obtain an updated digital twin;
identifying a drift of the endpoint device based on the updated digital twin; and
updating operation of the endpoint device based on the drift to manage the endpoint device.

18. The management system of claim 17, wherein the digital twin is a model of the endpoint device, and the model comprising a set of dimensions based on characteristics of the endpoint device.

19. The management system of claim 18, wherein each dimension of the set of dimensions has a corresponding scale that is based on the environmental conditions.

20. The management system of claim 19, wherein the model comprises a set of values corresponding to the set of dimensions, and each value of the set of values ranges within the corresponding scale for a corresponding dimension of the set of dimensions.
